(19) United States
(12) Patent Application Publication
(10) Pub. No.: US 2025/0261624 A1
(43) Pub. Date: Aug. 21, 2025

(54) Vehicular Accessory Adapter for Holster Accessory

(71) Applicant: William Frederick Hare, North Fort Myers, FL (US)

(72) Inventor: William Frederick Hare, North Fort Myers, FL (US)

(21) Appl. No.: 19/204,456

(22) Filed: May 9, 2025

(51) Int. Cl. A01K 97/10; B60R 9/06; B60R 9/08

(52) U.S. Cl. CPC A01K 97/10; B60R 9/06; B60R 9/08

(57) ABSTRACT

A vehicular accessory adapter attaches a holster accessory to a front vehicular mount, and includes attachment elements; a front connector having a main body, front connector openings, and a front connector upper body having upper body openings; and a spacer having spacer openings, and configured to be positioned between the front vehicular mount and the front connector. The attachment elements are configured to respectively extend through the front connector openings and to interface with the front vehicular mount to attach the front connector to the front vehicular mount, and the upper body openings are, positioned above the connector openings, and configured to facilitate attachment of the holster accessory to the front connector upper body.

### CROSS-REFERENCE TO RELATED DOCUMENTS

This document is related to and incorporates by reference in its entirety U.S. Pat. No. 11,713,003, entitled “Vehicular Accessory Adapter” and issued on Aug. 1, 2023 by William Frederick Hare.

### BACKGROUND OF THE INVENTION

The present invention relates to vehicular accessories and vehicular accessory mounting adapters.

### SUMMARY OF THE INVENTION

The present invention provides a vehicular accessory adapter that can attach a holster accessory to a front vehicular mount positioned at a front exterior portion of a vehicle having a front.

In an exemplary embodiment of the present invention, such an adapter can include first and second attachment elements; a front connector; and a spacer.

In an exemplary aspect, a front connector can include a main body, first and second front connector openings, and a front connector upper body extending from the main body and having first and second upper body openings.

In another exemplary aspect, a spacer can include first and second spacer openings, and can be configured to be positioned between the front vehicular mount and the front connector with the first and second attachment elements respectively extending through the first and second spacer openings.

In still yet another exemplary aspect, the first and second attachment elements can be configured to respectively extend through the first and second front connector openings and to interface with the front vehicular mount so as to attach the front connector to the front vehicular mount, and the first and second upper body openings can be, positioned above the first and second connector openings, and configured to facilitate attachment of the holster accessory to the front connector upper body.

In a further exemplary aspect, the front connector upper body can extends above the main body.

In an additional exemplary aspect, the front connector can include a front connector pin opening, the spacer can include a spacer pin opening, and the front connector and spacer pin openings can be configured to align when the spacer is positioned between the front vehicular mount and the front connector, so as to allow a pin to pass through the front connector and spacer pin openings.

In another exemplary aspect, the first and second front connector openings can be laterally spaced apart.

In yet another exemplary aspect, such an adapter can include third and fourth attachment elements configured to respectively extend through the first and second upper body openings and to attach the holster accessory to the front connector upper body.

In still another exemplary aspect, the holster accessory can include an open cavity configured to receive a fishing pole.

In another exemplary embodiment, the present invention can be provided as a vehicular holster accessory adapter kit configured to attach to a front vehicular mount positioned at a front exterior portion of a vehicle having a hood positioned below the front vehicular mount.

### BRIEF DESCRIPTION OF DRAWINGS

FIG. 1 illustrates a prior art vehicular having a prior art front vehicular mount located at a front portion of the vehicle.

FIG. 2 illustrates an exploded view of an exemplary vehicular accessory adapter having a front connector and a spacer.

FIG. 3 illustrates an exemplary arrangement of a front connector, spacer, pin, and first and second attachment elements.

FIG. 4 illustrates an outer view of an exemplary holster accessory attached to a front vehicular mount via an exemplary vehicular accessory adapter.

FIG. 5 illustrates an inner view of an exemplary holster accessory attached to a front vehicular mount via an exemplary vehicular accessory adapter.

FIG. 6 illustrates an exemplary holster accessory having a cavity with an exemplary fishing pole positioned therein.

### DETAILED DESCRIPTION OF THE INVENTION

It is an object of the present invention to provide a vehicular accessory adapter.

It is another object of the present invention to provide a vehicular accessory adapter that facilitates the attachment of a holster accessory to a vehicle.

It should be noted that this disclosure includes a plurality of embodiments each having a plurality of elements, aspects, and/or limitations and such elements, aspects, and/or limitations need not necessarily be interpreted as being conjunctively required by one or more embodiments of the present invention. In particular, all combinations of such elements, aspects, and/or limitations can enable a separate embodiment of the present invention, which may be claimed with particularity in the present or any future filed Patent Application. Moreover, such elements, aspects, and/or limitations disclosed herein, whether expressly or implicitly, are to be construed strictly as illustrative and enabling, and not necessarily limiting. Therefore, it is expressly set forth that any elements, aspects, and/or limitations, independently or in any combination of one of more thereof, are merely illustratively representative of one or more embodiments of the present invention and are not to be construed as necessary in a strict sense.

Further, to the extent the same element, aspect, and/or limitation is defined differently anywhere within this disclosure, whether expressly or implicitly, the broader definition is to take absolute precedence, with the distinctions encompassed by the narrower definition to be strictly construed as optional.

Illustratively, perceived benefits of the present invention can include functional utility, whether expressly or implicitly stated herein, or apparent herefrom. However, it is expressly set forth that these benefits are not intended as exclusive. Therefore, any explicit, implicit, or apparent benefit from the disclosure herein is expressly deemed as applicable to the present invention.

Accordingly, it will be understood that the above description of the embodiments of the present invention are susceptible to various modifications, changes, and adaptations, and the same are intended to be comprehended within the meaning and range of equivalents apparent to one of ordinary skill in the art.

According to the present invention, components of the present invention can be formed from any one or more materials or combinations of materials, such as one or more of plastic, rubber, wood, metal, a crystalline material, or any other man-made or naturally occurring material, for example and not in limitation, insofar as the same if functionally consistent with the invention as described. Further, such components can be manufactured in any one or more functionally compatible manners, such as through molding, machining, stamping, etc.

FIG. 1 illustrates an exemplary environment of the present invention, which can include a prior art vehicle 1, such as the sixth-generation Ford® Bronco®, having a prior art front vehicular mount 2 located at a front F end of the vehicle.

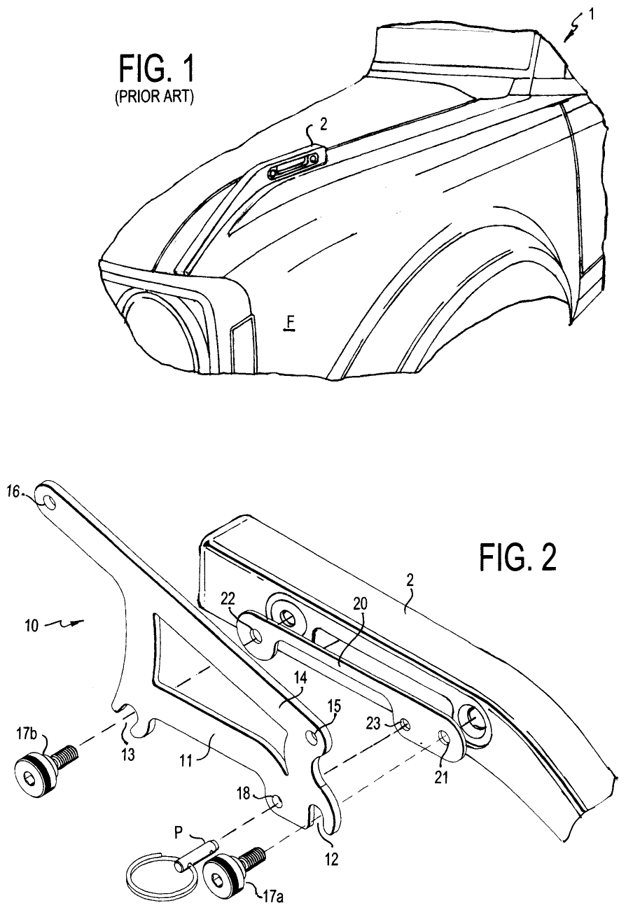

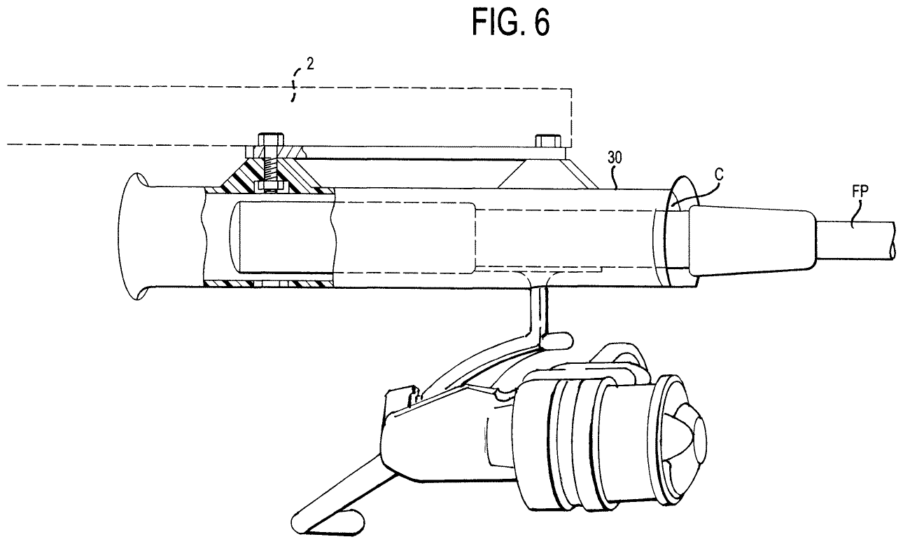

FIG. 2 illustrates an exploded view of an exemplary vehicular accessory adapter, which can be configured to attach a holster accessory (see FIG. 4-6) to a front vehicular mount 2. As illustratively shown, in an exemplary aspect of the present invention, such an adapter can include a front connector 10 having a main body 11, first and second front connector openings 12,13, and a front connector upper body 14 extending from the main body and having first and second upper body openings 15,16. As further illustrated, an adapter according to the present invention can additionally include first and second attachment elements 17a,17b, and a spacer 20 having first and second spacer openings 21,22 and being configured to be positioned between the front vehicular mount 2 and the front connector 10 with the first and second attachment elements respectively extending through the first and second spacer openings.

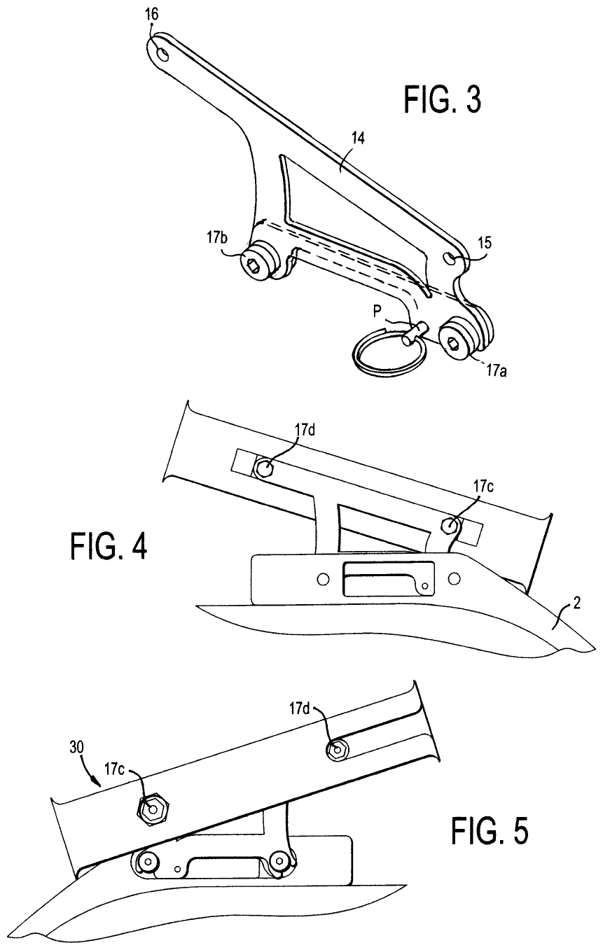

As illustrated in FIGS. 2 and 3, in another exemplary aspect of the present invention, first and second attachment elements 17a, 17b can be configured to respectively extend through the first and second front connector openings 12,13 and to interface with the front vehicular mount 2 so as to attach front connector 10 to front vehicular mount 2. In still another exemplary aspect, front connector upper body 14 can extend above main body 11, which can provide additional clearance between front vehicular mount 2 and an accessory engaged with the front connector upper body.

In another exemplary aspect, as illustrated in FIGS. 2 and 3, front connector 10 can additionally include a front connector pin opening 18 and spacer 20 can further include a spacer pin opening 23, both of which can align when the spacer is positioned between front vehicular mount 2 and the front connector. As illustratively shown, such alignment can allow a pin P to pass through the front connector and spacer pin openings 18,23, which can facilitate engagement of front connector 10 and spacer 20 to front vehicular mount 2.

In still another exemplary aspect, in one exemplary embodiment, first and second front connector openings can be laterally spaced apart, however, the same may be spaced vertically insofar as compatible with a front vehicular mount 2.

As illustrated in FIGS. 4-6, in one exemplary embodiment, a holster accessory 30 can include a cylindrical shape and can be attached to front connector upper body 14 via respective engagement of third and fourth attachment elements 17c, 17d with first and second upper body openings 15,16. As further illustrated, holster accessory 30 can include an open cavity C in which compatibly-shaped items, such as a fishing pole FP, can be disposed.

It should be noted that according to the present invention, an attachment element can be provided as any one or more structures that can cooperatively provide an attachment or engagement function, such as screw, catch, magnet, clamp, quick-connect, latch/patch pin combination, nut-bolt combination, for example and not in limitation, insofar as functionally compatible with the present invention.

It should be particularly noted that illustratively shown and described shapes and connection structures and elements herein are not to be necessarily construed as limiting. Accordingly, a broad range of functionally compatible shapes and connection structures and elements are expressly intended to be equivalents insofar as functionally compatible with the present invention.

It will be apparent to one of ordinary skill in the art that the manner of making and using the claimed invention has been adequately disclosed in the above-written and attached description of the exemplary embodiments and aspects of the present invention.

It should be understood, however, that the invention is not necessarily limited to the specific embodiments, aspects, arrangement, and components shown and described above, but may be susceptible to numerous variations within the scope of the invention. For example, the present invention contemplates the utilization of various attachment structures and attachment elements, which are not intended as limiting, but rather illustrative and enabling. Indeed, the present invention contemplates a broad range of known and apparent structures and elements as applicable equivalents insofar as functionally consistent with the present invention.

Therefore, the specification and drawings are to be regarded in an illustrative and enabling, rather than a restrictive, sense.

Accordingly, it will be understood that the above description of the embodiments of the present invention are susceptible to various modifications, changes, and adaptations, and the same are intended to be comprehended within the meaning and range of equivalents apparent to one of ordinary skill in the art.

1. A vehicular accessory adapter configured to attach a holster accessory to a front vehicular mount positioned at a front exterior portion of a vehicle having a hood positioned below the front vehicular mount, said adapter comprising:
first and second attachment elements;
a front connector having a main body, first and second front connector openings, and a front connector upper body extending from the main body and having first and second upper body openings; and
a spacer having first and second spacer openings, and being configured to be positioned between the front vehicular mount and said front connector with said first and second attachment elements respectively extending through the first and second spacer openings;
wherein said first and second attachment elements are configured to respectively extend through the first and second front connector openings and to interface with the front vehicular mount so as to attach said front connector to the front vehicular mount, and the first and second upper body openings are, positioned above the first and second connector openings, and configured to facilitate attachment of the holster accessory to the front connector upper body.

2. The adapter of claim 1, wherein the front connector upper body extends above the main body.

3. The adapter of claim 1, wherein said front connector includes a front connector pin opening, said spacer includes a spacer pin opening, and the front connector and spacer pin openings are configured to align when said spacer is positioned between the front vehicular mount and said front connector, so as to allow a pin to pass through the front connector and spacer pin openings.

4. The adapter of claim 1, wherein the first and second front connector openings are laterally spaced apart.

5. The adapter of claim 1, wherein the holster accessory includes third and fourth attachment elements configured to respectively extend through the first and second upper body openings and to attach the holster accessory to the front connector upper body.

6. The adapter of claim 5, wherein the holster includes an open cavity configured to receive a fishing pole.

7. A vehicular holster accessory adapter kit configured to attach to a front vehicular mount positioned at a front exterior portion of a vehicle having a hood positioned below the front vehicular mount, said adapter comprising:
a holster accessory;
first, second, third, and fourth attachment elements;
a front connector having a main body, first and second front connector openings, and a front connector upper body extending from the main body and having first and second upper body openings; and
a spacer having first and second spacer openings, and being configured to be positioned between the front vehicular mount and said front connector with said first and second attachment elements respectively extending through the first and second spacer openings;
wherein said first and second attachment elements are configured to respectively extend through the first and second front connector openings and to interface with the front vehicular mount so as to attach said front connector to the front vehicular mount, the first and second upper body openings are, positioned above the first and second connector openings, and said third and fourth attachment elements are configured to respectively extend through the first and second upper body openings and to attach the holster accessory to the front connector upper body.

8. The kit of claim 7, wherein the front connector upper body extends above the main body.

9. The kit of claim 7, wherein said front connector includes a front connector pin opening, said spacer includes a spacer pin opening, and the front connector and spacer pin openings are configured to align when said spacer is positioned between the front vehicular mount and said front connector, so as to allow a pin to pass through the front connector and spacer pin openings.

10. The kit of claim 7, wherein the first and second front connector openings are laterally spaced apart.

11. The kit of claim 7, wherein said holster accessory includes an open cavity configured to receive a fishing pole.
